(19) United States
(12) Patent Application Publication
(10) Pub. No.: US 2026/0086535 A1
(43) Pub. Date: Mar. 26, 2026

(54) DISPLAY DEVICE FOR MACHINE TOOL

(71) Applicant: FANUC CORPORATION, Minamitsuru-gun, Yamanashi (JP)

(72) Inventors: Yuutarou HORIKAWA, Yamanashi (JP); Masashi YASUDA, Yamanashi (JP); Iwao MAKINO, Yamanashi (JP); Makoto HAGA, Yamanashi (JP)

(73) Assignee: FANUC CORPORATION, Minamitsuru-gun, Yamanashi (JP)

(21) Appl. No.: 19/108,929

(22) PCT Filed: Sep. 21, 2022
(86) PCT No.: PCT/JP2022/035088

§ 371 Date: Mar. 5, 2025

(51) Int. Cl. G05B 19/4155; B23B 25/02

(52) U.S. Cl. CPC G05B 19/4155; B23B 25/02; G05B 2219/50176

(57) ABSTRACT

The present invention provides a technology for enabling intuitive grasp of a change in machining state due to a change in input values of machining conditions and oscillation conditions in oscillation cutting. A display device 1 for a machine tool that machines a workpiece W while oscillating a cutting tool T and the workpiece W relative to each other comprises a condition input unit 11 that receives at least one input of the machining conditions and oscillation conditions by input means 30 (slide bars 31, 32, 35, 36) with which input values can be changed continuously, a machining state calculation unit 12 that calculates the machining state according to the input of the machining conditions and oscillation conditions, and a display unit 13 that displays the calculated machining state.

### TECHNICAL FIELD

The present disclosure relates to a display device for a machine tool.

### BACKGROUND ART

During cutting in which a cutting tool cuts a workpiece, chips are continuously generated. Oscillation cutting has been known in which a cutting tool cuts a workpiece while the cutting tool and the workpiece are relatively oscillated in order to avoid a situation in which entanglement of chips with the workpiece and the cutting tool or a similar behavior of the chips causes machining defects, machine failures, and the like. In the oscillation cutting, the oscillation frequency and the oscillation amplitude are adjusted such that a tool path, which is a trajectory of the cutting tool, is made to partially overlap with the previous tool path. As a result, the cutting edge of the cutting tool is caused to perform idle motion while being separate from the surface of the workpiece, which is called air cutting, whereby the chips are shredded. A known machine tool that performs this type of oscillation cutting receives an input of numerical values indicating oscillation conditions such as the oscillation frequency and the oscillation amplitude, and the input results are checked via a display device (for example, see Patent Document 1).

### CITATION LIST

### Patent Document

Patent Document 1: Japanese Patent No. 6843313

### DISCLOSURE OF THE INVENTION

### Problems to be Solved by the Invention

Meanwhile, in the oscillation cutting, a waveform is obtained from an input of the numerical values indicating the oscillation conditions, and then, whether or not the previous path and the current path intersect with each other is checked based on the obtained waveform. However, the display device of the known art does not make it easy to grasp how a machining state, such as the waveform, whether or not chip shredding Is possible, a chip length, a surface roughness, and the like, changes in a case where the machining condition and the oscillation condition are changed.

The present disclosure has been achieved in view of the above-described disadvantages, and an object of the present disclosure to provide a technique pertaining to oscillation cutting and making it possible to intuitively grasp a change in a machining state resulting from a change in an input value indicating a machining condition or a change in an input value indicating an oscillation condition.

### Means for Solving the Problems

The present disclosure provides a display device for a machine tool that performs machining while relatively oscillating a cutting tool and a workpiece, the display device including: a condition input unit configured to receive an input of at least one of a machining condition or an oscillation condition via an input section that allows an input value to be consecutively changed; a machining state calculation unit configured to calculate a machining state in response to an input of the machining condition and the oscillation condition; and a display unit configured to display the machining state calculated.

### Effects of the Invention

The present disclosure can provide a technique pertaining to oscillation cutting and making it possible to intuitively grasp a change in a machining state resulting from a change in an input value indicating a machining condition or a change in an input value indicating an oscillation condition.

### BRIEF DESCRIPTION OF THE DRAWINGS

FIG. 1 is a diagram for explaining oscillation cutting;

FIG. 2 is a functional block diagram of a display device for a machine tool according to a first embodiment;

FIG. 3 is a functional block diagram of a machining state calculation unit;

FIG. 4 is a diagram illustrating a cutting path as a machining state;

FIG. 5 is a diagram illustrating a maximum distance between cutting paths;

FIG. 6 is a diagram illustrating an example of an image n input section and an image or a machining state d splayed on a display unit before a condition change;

FIG. 7 is a diagram illustrating another example of an image of the input section and an image of the machining state displayed on the display unit before a condition change;

FIG. 8 is a diagram illustrating an example of an image of the input section and an image of the machining state displayed on the display unit after a condition change;

FIG. 9 is a diagram illustrating an example of an image or an input section that clearly shows a range in which chip shredding is possible, according to a second embodiment; and

FIG. 10 is a functional block diagram of a display device for a machine tool according to a third embodiment.

### PREFERRED MODE FOR CARRYING OUT THE INVENTION

The following describes embodiments of the present disclosure in detail with reference to the drawings.

### First Embodiment

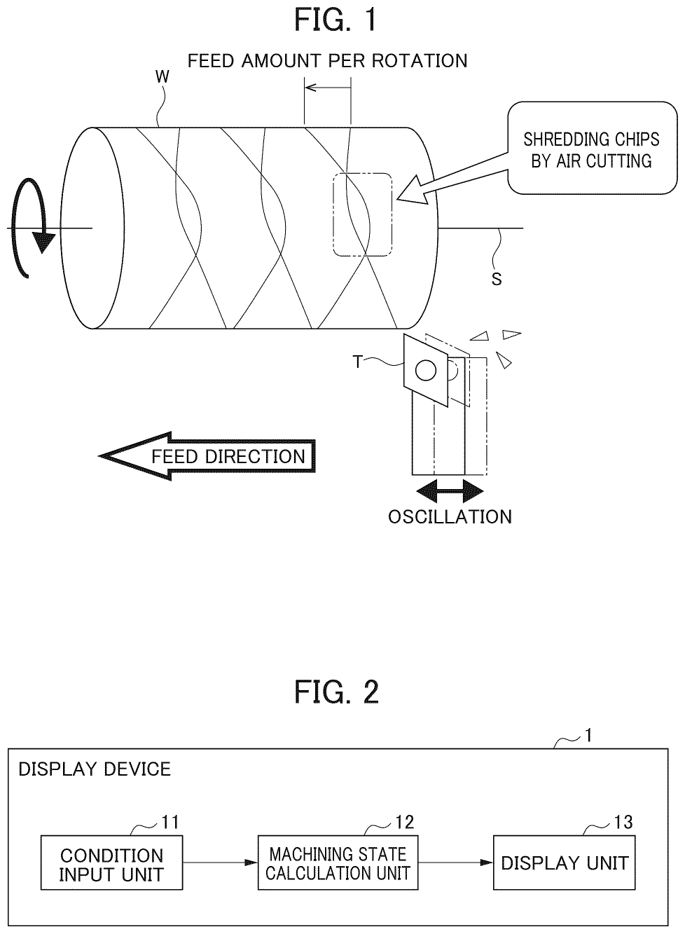

The display device 1 for a machine tool according to a first embodiment of the present invention is adapted for oscillation cutting in which a cutting tool cuts a workpiece while the cutting tool and the workpiece are relatively oscillated. First, the oscillation cutting will be described with reference to FIG. 1.

FIG. 1 is a diagram for explaining the oscillation cutting. In the example of the oscillation cutting illustrated in FIG. 1, at least one spindle S that relatively rotates the cutting tool T and the workpiece W and at least one feed shaft that moves the cutting tool T relative to the workpiece W are operated, so that cutting is performed while the cutting tool T and the workpiece W are relatively oscillated in a feed direction, concurrently with the relative rotation of the cutting tool T and the workpiece W. At this time, a setting is made on the tool path, which is the trajectory of the cutting tool T, such that the current path partially overlaps with the previous path. Specifically, since a portion machined in the previous path is partially included in the current path, the cutting edge of the cutting tool T is caused to perform idle motion while being separate from the surface of the workpiece W, which is called air cutting, whereby chips are shredded.

It should be noted that, for the oscillation cutting performed in the present embodiment, the workpiece is not limited to any shape. Specifically, the oscillation cutting according to the present embodiment is applicable to a case where a plurality of feed axes (a Z-axis and an X-axis) are necessary to machine a workpiece having a tapered portion or an arc-shaped portion on a surface thereof to be machined and a case where a specific single feed axis (a Z-axis) is sufficient to machine a workpiece having a circular columnar shape or a cylindrical shape

Next, a configuration of the display device 1 for a machine tool will be described. FIG. 2 is a functional block diagram of the display device 1 for a machine tool according to an embodiment of the present invention. The display device 1 for a machine tool according to the present embodiment is constituted by, for example, a computer including memories such as a read only memory (ROM) and a random access memory (RAM), a central processing unit (CPU), and a communication control unit, which are connected to each other via a bus. The functions and operations of the functional units are implemented by cooperation between the CPU and the memories incorporated in the computer and control programs stored in the memories. The display device 1 for a machine tool may be constituted by a computer numerical controller (CNC), a programmable logic controller (PLC), or the like. Alternatively, the display device 1 for a machine tool may be connected to a host computer that outputs, in addition to a machining program, machining conditions such as a rotation speed and the like.

As illustrated in FIG. 2, the display device 1 for a machine tool includes a condition input unit 11, a machining state calculation unit 12, and a display unit 13.

The condition input unit 11 receives art input of at least one or a machining condition or an oscillation condition via an input section that allows an input value to be consecutively changed. A configuration example of the input section will be described later.

Here, the machining condition includes at least information regarding a feed amount per relative rotation of the cutting tool and the workpiece and information regarding a shape of a cutting edge of the cutting tool. In addition, the machining condition includes, for example, information regarding a spindle speed S (1/min) of a spindle, a feed rate (mm/min) for the cutting tool, a workpiece radius (mm), a clearance angle (°) or the cutting tool, and the like. An example of the information regarding the feed amount per relative rotation of the cutting tool and the workpiece is a feed amount F per rotation (mm/rev). An example of the information regarding the shape of the cutting edge of the cutting tool is the tool nose radius (mm).

The oscillation condition includes information regarding the number of oscillations per relative rotation of the cutting tool and the workpiece, and information regarding an oscillation amplitude with respect to the feed amount per relative rotation of the cutting tool and the workpiece. An example of the information regarding the number of oscillations per relative rotation of the cutting tool and the workpiece is an oscillation frequency multiple I (times) that indicates an oscillation frequency per rotation of the spindle. An example of the information regarding the oscillation amplitude with respect to the feed amount per relative rotation of the cutting tool and the workpiece is an oscillation amplitude multiple K (times) that indicates the magnitude of an oscillation amplitude with respect to the magnitude of a feed amount per rotation of the spindle. The oscillation frequency multiple I (times) may be directly designated, or may be calculated from an oscillation frequency (Hz), which is designated beforehand, and a spindle speed S (1/min). Likewise, the oscillation amplitude multiple K (times) may be directly designated, or may be calculated from an oscillation amplitude (mm) which is designated beforehand, a feed rate (mm/min), and a spindle speed S (1/min)

The machining state calculation unit 12 calculates a machining state based on the machining condition and the oscillation condition inputted from the condition input unit 11. Here, the machining state includes a cutting path, whether or not chip shredding is possible, a chip length, a surface roughness of the workpiece W, an oscillation frequency, an oscillation amplitude, a maximum acceleration of an oscillation, and the like.

Examples of a determination method and a calculation method that the machining state calculation unit 12 executes will be described. The following description refers to mathematical expressions as necessary. It should be noted that in the mathematical expressions, Y represents a coordinate value (mm) in a feed direction, f represents a feed amount F (mm/rev) oar rotation of the spindle, S represents a spindle speed (1/min), t represents time (sec), I represents the oscillation frequency multiple (times), K represents the oscillation amplitude multiple (times), r represents a workpiece radius (mm) that is a radius of the workpiece W, R represents a shape of a cutting edge (mm) such as a tool nose radius, and h represents a maximum height Rz (μm) that is an indicator of a surface roughness.

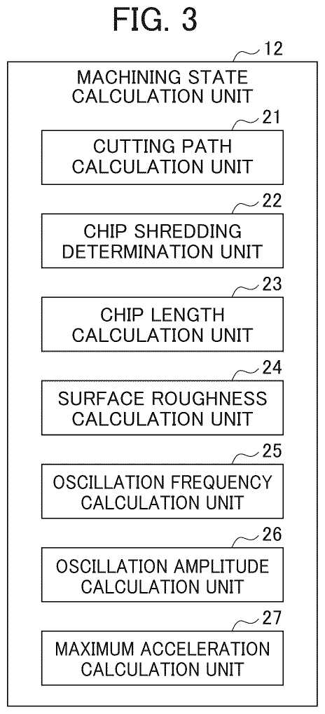

FIG. 3 is a functional block diagram of the machining state calculation unit 12. As illustrated in FIG. 3, the machining state calculation unit 12 includes a cutting path calculation unit 21, a chip shredding determination unit 22, a chip length calculation unit 23, a surface roughness calculation unit 24, an oscillation frequency calculation unit 25, an oscillation amplitude calculation unit 26, and a maximum acceleration calculation unit 27.

The cutting path calculation unit 21 calculates a relative cutting path of the cutting tool T and the workpiece W based on the machining condition and the oscillation condition. The machining condition used in the calculation of the cutting path includes, for example, the spindle speed S (1/min) of the spindle and the feed amount F (mm/rev) per rotation of the spindle. The oscillation condition used in the calculation of the cutting path includes, for example, the oscillation frequency multiple I (times) that indicates an oscillation frequency per rotation of the spindle and the amplitude multiple K (times) that indicates the magnitude of an oscillation amplitude with respect to the magnitude of a feed amount per rotation of the spindle.

The cutting path calculation unit 21 calculates a coordinate value Y (mm) in the feed direction of the cutting path according to Expression (1) below, and derives an oscillation waveform as the cutting path.

$$Y = \frac{fS}{60} t + \frac{Kf}{2} \{ cos ( 2 π \frac{SI}{60} t ) - 1 \} \qquad [ Exp . 1 ]$$

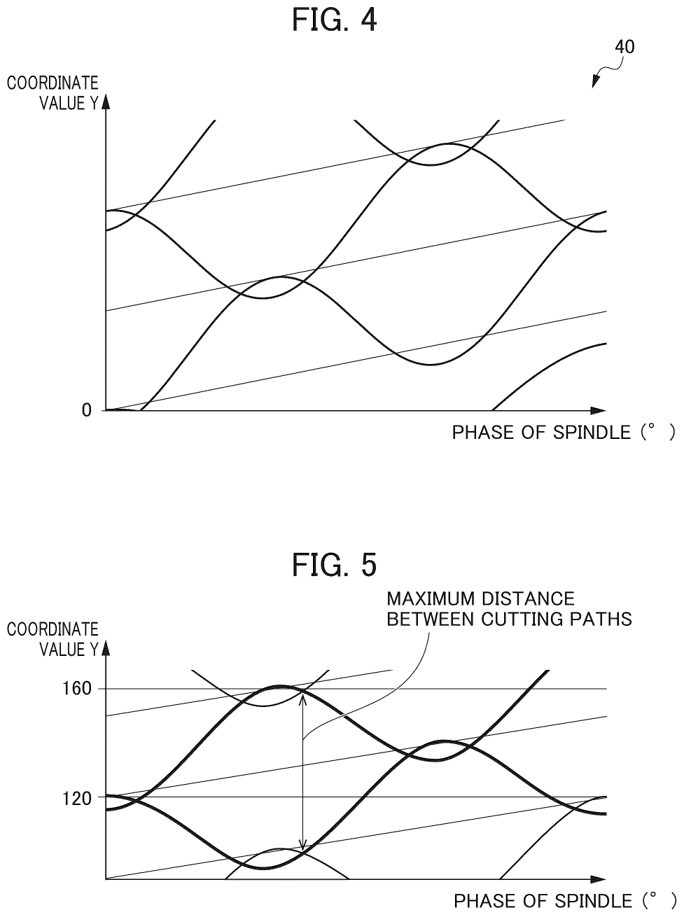

FIG. 4 is a diagram illustrating a cutting path. As illustrated in FIG. 4, the cutting path calculation unit 21 outputs, to the display unit 13, a graph plotting solutions to Expression (1) as a machining state 40. In other words, the oscillation waveform is displayed as the machining state 40.

The chip shredding determination unit 22 determines whether or not chip shredding is possible. The oscillation condition used to determine whether or not chip shredding is possible includes, for example, the oscillation frequency multiple I (times) that indicates an oscillation frequency per rotation of the spindle, and the oscillation amplitude multiple K (times) that indicates the magnitude of an oscillation amplitude with respect to the magnitude of a feed amount per rotation of the spindle.

The chip shredding determination unit 22 determines whether or not chip shredding is possible according to the Expression (2) below. The chip shredding determination unit 22 determines that chip shredding is possible when Expression (2) is satisfied, and determines that chip shredding is impossible when Expression (2) is not satisfied.

$$K \times \vert sin π I \vert \geq 1 \qquad [ Exp . 2 ]$$

The chip length calculation unit 23 calculates the length of chips of the workpiece W based on the machining condition and the oscillation condition. The machining condition used in the calculation or the chip length includes, for example, the workpiece radius (mm), which is the radius of the workpiece W. The oscillation condition used in the calculation of the chip length includes, for example, the oscillation frequency multiple I (times) that indicates an oscillation frequency per rotation of the spindle. The chip length calculation unit 23 calculates the chip length according to the Expression (3) below.

$$2 π r / I \qquad [ Exp . 3 ]$$

The surface roughness calculation unit 24 calculates a surface roughness of the workpiece W based on the machining condition and the oscillation condition. The machining condition used in the calculation of the surface roughness includes, for example, the feed amount F (mm/rev) per rotation of the spindle and the tool nose radius (mm), which indicates the shape of the cutting edge of the cutting tool T. The oscillation condition used in the calculation of the surface roughness includes, for example, the oscillation frequency multiple I (times) that indicates an oscillation frequency per rotation of the spindle and the oscillation amplitude multiple K (times) that indicates the magnitude of an oscillation amplitude with respect to the magnitude of a feed amount per rotation of the spindle.

For example, the surface roughness calculated by the surface roughness calculation unit. 24 includes at least one of the following: an arithmetic mean roughness, a maximum height that is a maximum value of a distance between a peak and a valley, a maximum peak height that is a maximum value of a height from an average line of the surface, a maximum valley depth that is the absolute value of a minimum value of a height from the average line of the surface, an average height that is an average value or heights or contour curve elements of pairs each composed of adjacent peak and valley, a maximum cross-sectional height that is the sum of a maximum value of a peak height and a maximum value of a valley depth of the contour curve elements, or a load length ratio that is a ratio of a load length of the contour curve elements at a predetermined cutting level (height % or μm) to an evaluation reference length.

Referring to FIG. 5, an example will be described in which the surface roughness calculation unit 24 calculates a maximum height Rz as the surface roughness. FIG. 5 is a diagram illustrating a maximum distance between cutting paths. FIG. 5 shows a portion where the distance between the cutting paths is maximized. In the present embodiment, coordinate values Y of the locations at which the distance between the cutting paths is maximized is calculated according to Expression (1) above, and the distance between the calculated coordinate values is set as the maximum distance between the cutting paths. Then, for example, in a case where the maximum height Rz, which is the maximum value of a distance between a peak and a valley is calculated as the surface roughness, h is calculated as the maximum height Rz by substituting the tool nose radius (mm) into Expression (4) below and by substituting the maximum distance between the cutting paths obtained as described above into t of Expression (4) below.

$$h = \frac{{f}^{2}}{8 R} \times 1000 \qquad [ Exp . 4 ]$$

As described above, the surface roughness Is not limited to the maximum height Rz. The surface roughness may be, for example, an arithmetic mean roughness Ra.

The oscillation frequency calculation unit 25 calculates an oscillation frequency of a relative oscillation of the cutting tool T and the workpiece W, based on the machining condition and the oscillation condition. The machining condition used in the calculation of the oscillation frequency includes, for example, the spindle speed S (1/min) of the spindle. The oscillation condition used in the calculation or the oscillation frequency includes, for example, the oscillation frequency multiple I (times) that indicates an oscillation frequency per rotation of the spindle. The oscillation frequency calculation unit 25 calculates the oscillation frequency according to Expression (5) below.

$$S [ {min}^{- 1} ] / 60 \times I \qquad [ Exp . 5 ]$$

The oscillation amplitude calculation unit 26 calculates an oscillation amplitude of a relative oscillation of the cutting tool T and the workpiece W, based on the machining condition and the oscillation condition. The machining condition used in the calculation of the oscillation amplitude includes, for example, the feed amount F per rotation (mm/rev) The oscillation condition used in the calculation of the oscillation amplitude includes, for example, the oscillation amplitude multiple K (times) that indicates the magnitude of an oscillation amplitude with respect to the magnitude of a feed amount per rotation of the spindle. The oscillation amplitude calculation unit 26 calculates the oscillation amplitude according to Expression (6) below.

$$f \times K \qquad [ Exp . 6 ]$$

The maximum acceleration calculation unit 27 calculates a maximum acceleration of a relative oscillation of the cutting tool T and the workpiece W, based on the machining condition and the oscillation condition. The machining condition used in the calculation of the maximum acceleration includes, for example, the spindle speed S (1/min) of the spindle and the feed amount E (mm/rev) per rotation. The oscillation condition used in the calculation of the maximum acceleration includes, for example, the oscillation amplitude multiple K (times) that indicates the magnitude of an oscillation amplitude with respect to the magnitude of a feed amount per rotation of the spindle and the oscillation frequency multiple I (times) that indicates an oscillation frequency per rotation of the spindle. The maximum acceleration calculation unit 27 calculates the maximum acceleration according to Expression (7) below.

$$\frac{Kf}{2} \times {( π \frac{SI}{60} )}^{2} \qquad [ Exp . 7 ]$$

In the foregoing the configuration of the machining state calculation unit 12 has been described. It should be noted that the determination method and calculation method described above are examples, and the machining state may be calculated by a method different from the method using the above-described mathematical expressions.

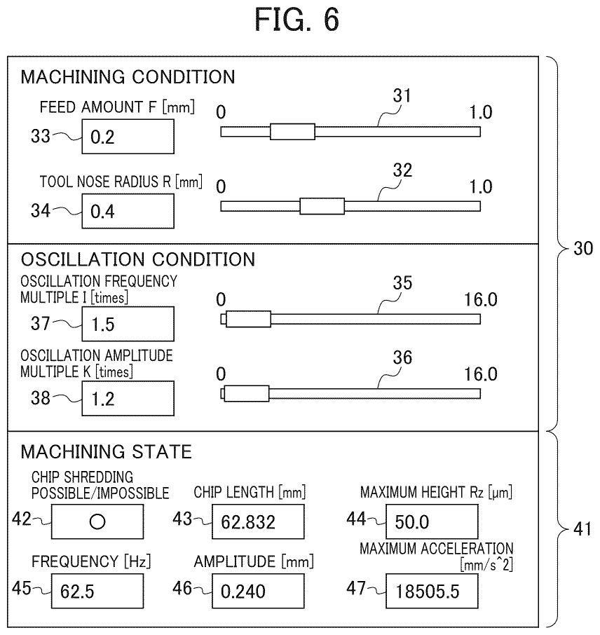

Next, the display unit 13 will be described. FIG. 6 is a diagram illustrating an example of an image of the input section and an image of the machining state displayed on the display unit 13 before a condition change.

As illustrated in FIG. 6, the display unit 13 displays both the input section 30 via which the machining condition and the oscillation condition are inputted and the machining state 41 calculated by the machining state calculation unit 12. In the present embodiment, the display unit 13 is assumed to further display the machining state 40 indicating the oscillation waveform illustrated in FIG. 4, together with the images illustrated in FIG. 6.

The input section 30 includes a block for the machining condition, and a slider bar 31 for inputting the feed amount F [mm] and a slider bar 32 for inputting the tool nose radius [mm] are displayed in the block. On the left of the slider bar 31, a window 33 indicating a numerical value of the result of an input of the feed amount F [mm] is displayed. In this example, an operator has operated the slider bar to input a numerical value of 0.2. On the left of the slider bar 32, a window 34 indicating a numerical value of the result of an input of the tool nose radius [mm] is displayed. In this example, the operator has operated the slider bar to input a numerical value of 0.4, It is assumed that the spindle speed S (1/min) of the spindle and the like have been set in advance or by way of another input section

The input section 30 includes a block for the oscillation condition, and a slider bar 35 for inputting the oscillation frequency multiple I (times) and a slider bar 36 for inputting the oscillation amplitude multiple K (times) are displayed in the block. On the left of the slider bar 35, a window 37 indicating a numerical value of the result of an input of the oscillation frequency multiple I (times) is displayed. In this example, the operator has operated the slider bar 35 to input a numerical value of 1.5. On the left of the slider bar 36, a window 38 indicating a numerical value of the result of an input of the oscillation amplitude multiple K (times) is displayed. In this example, the operator has operated the slider bar 36 to input a numerical value of 1.2.

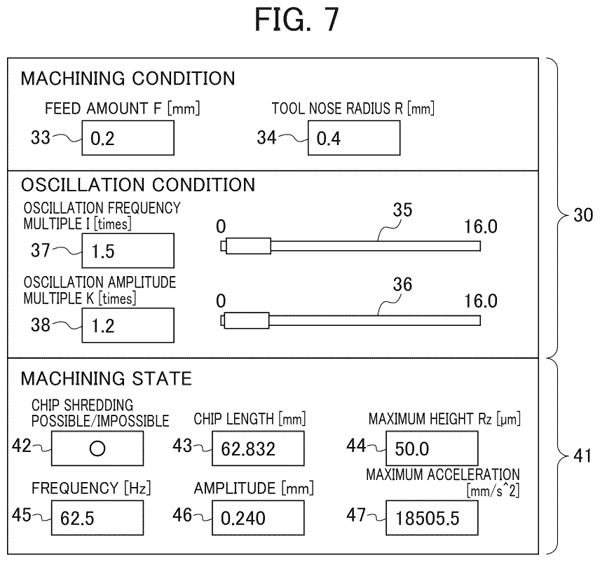

FIG. 7 is a diagram illustrating another example of an image of the input section and an image of a machining state displayed on the display unit before a condition change. In the example illustrate in FIG. 6, the scroll bars are used for inputting both the machining condition and the oscillation condition. However, as illustrated in FIG. 7, the slider bar may be used for a part of the machining condition and the oscillation condition. It is possible to adopt a configuration in which the slider bar is used only for inputting a condition to be consecutively checked, and a condition that can be checked in a non-consecutive manner is inputted in the form of a numerical value.

In a block of the machining state 41, output results rom the machining state calculation unit 12 are displayed. In this example, the block shows a window 12 for showing whether or not chip shredding is possible, and the symbol in the window 42 indicates that chip shredding is possible. Furthermore, in the block, numerical values based on the machining condition and the oscillation condition are respectively displayed in a window 43 for showing the calculation result of a chip length [mm], a window 44 for showing the calculation result of a maximum height Rz [μm], which is an indicator of the surface roughness, a window 45 for showing the calculation result of a frequency [Hz], a window 46 for showing the calculation result of an amplitude [mm], and a window 47 for showing the calculation result of a maximum acceleration [mm/s-]

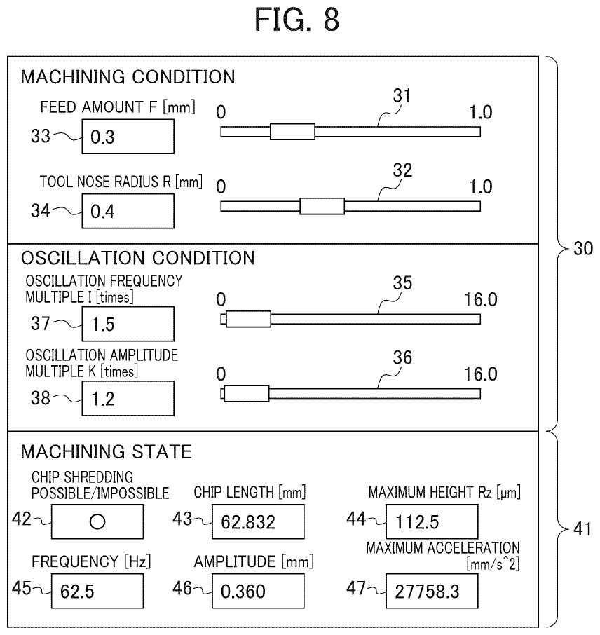

FIG. 8 is a diagram illustrating an example of an image of: the input section and an image of the machining state displayed on the display unit after a condition change. In the example illustrated in FIG. 8, the feed amount F [mm] of the machining condition is chanced from 0.2 to 0.3, whereas the numerical values of the tool nose radius [mm], the oscillation amplitude multiple K (times), and the oscillation frequency multiple I (times) remain unchanged. In response to an input of a new condition, the machining state calculation unit 12 determines and calculates the machining state 41 again based on the result of the input. In the example illustrated in FIG. 8, the maximum height Rz [μm] shown in the window 44 is changed from 50.0 to 112.5, the amplitude [mm] shown in the window 46 is changed from 0.240 to 0.360, and the maximum acceleration [mm/s²] shown in the window 47 is changed from 18505.5 to 27758.3. The output result of whether or not chip shredding is possible shown in the window 42, the numerical value of the chip length [mm] shown in the window 43, and the numerical value of the frequency [Hz] remain unchanged.

The machining state calculation unit 12 further re-outputs, to the display unit 13, the machining state 40 in the form of the oscillation waveform (cutting path) illustrated in FIG. 4, based on the input of the changed condition.

In the present embodiment, the re-outputting based on a change in the machining condition and the oscillation condition takes place in synchronization with the operation on the input section 30. Specifically, in response to operation on at least one of the slider bar 31 via which the feed amount F [mm] is inputted, the slider bar 32 via which the tool nose radius [mm] is inputted, the slider bar 35 via which the oscillation frequency multiple I [times] is inputted, or the slider bar 36 via which the oscillation amplitude multiple K [times] is inputted, the determination result and the numerical value that correspond to the changed input value are changed in synchronization, in the machining state 40 displaying the cutting path and in the other machining state 41.

According to the present embodiment described above, the display device 1 for a machine tool that performs machining while relatively oscillating a cutting tool T and a workpiece W exerts the following effects.

The display device 1 for a machine tool according to the present embodiment includes: a condition input unit 11 that receives an input of at least one of a machining condition or an oscillation condition via an input section 30 (slider bar 31, 32, 35, 36) that allows an input, value to be consecutively changed; a machining state calculation unit 12 that calculates a machining s at in response to an input of the machining condition and the oscillation condition; and a display unit 13 that displays the calculated machining state. This feature allows an operator to intuitively grasp how the machining state changes by continuously sliding the slider bar 31, 32, 35, 36, and makes it possible to reduce the time and effort associated with the machining condition and the input condition.

The machining state calculation unit 12 of the present embodiment includes at least one of: a cutting path calculation unit 21 that calculates a relative cutting path of the cutting tool T and the workpiece W; a chip shredding determination unit 22 that determines whether or not chip shredding is possible; a chip length calculation unit 23 that calculates a length of chips of the workpiece W; a surface roughness calculation unit 24 that calculates a surface roughness of the workpiece W; an oscillation frequency calculation unit 25 that calculates an oscillation frequency of a relative oscillation or the cutting tool T and the workpiece W; an oscillation amplitude calculation unit 26 that calculates an oscillation amplitude of a relative oscillation of the cutting tool T and the workpiece W; or a maximum acceleration calculation unit 27 that calculates a maximum acceleration of a relative oscillation of the cutting tool. T and the workpiece W. This feature allows the operator to input the machining condition and the oscillation condition while checking various output results shown in the machining state 40 or the machining state 41.

According to the present embodiment, a feed amount per relative rotation of the cutting tool T and the workpiece W (feed amount F), information regarding the number of oscillations per relative rotation of the cutting tool T and the workpiece W (oscillation frequency multiple I), and information regarding an oscillation amplitude with respect to the feed amount per relative rotation of the cutting tool T and the workpiece W (oscillation amplitude multiple K) are inputted to the cutting path calculation unit 21 of the machining state calculation unit 12. This feature allows the operator to perform the input operation while checking a cutting path that is re-outputted in synchronization with the input value.

According to the present embodiment, the information regarding the number of oscillations per relative rotation of the cutting tool T and the workpiece W (oscillation frequency multiple I) and the information regarding an oscillation amplitude with respect to the feed amount per relative rotation of the cutting tool T and the workpiece W (oscillation amplitude multiple K) are inputted to the chip shredding determination unit 22 of the machining state calculation unit 12. This feature allows the operator to perform the input operation while checking a determination result outputted in synchronization with the input value.

According to the present embodiment, the information regarding the number of oscillations per relative rotation or the cutting tool T and the workpiece W (oscillation frequency multiple I) and information including a distance from the center of the relative rotation of the cutting tool T and the workpiece W (workpiece radius (mm)) are inputted to the chip length calculation unit 23 of the machining state calculation unit 12. This feature allows the operator to perform the input operation while checking a length of chips that is outputted in synchronization with the input value.

According to the present embodiment, the feed amount per relative rotation of the cutting tool T and the workpiece W (feed amount F), the cutting edge shape or the cutting tool T (tool nose radius), the information regarding the number of oscillations per relative rotation of the cutting tool T and the workpiece W (oscillation frequency multiple I), and the information regarding an oscillation amplitude with respect to the feed amount per relative rotation of the cutting tool T and the workpiece W (oscillation amplitude multiple K) are inputted to the surface roughness calculation unit 24 of the machining state calculation unit 12. This feature allows the operator to more easily perform the input operation while checking a surface roughness indicator (maximum height Rz) that is re-outputted in synchronization with the input value.

According to the present embodiment, the relative spindle speed of the cutting tool T and the workpiece W (spindle speed S) and the information regarding the number of oscillations per relative rotation of the cutting tool T and the workpiece W (oscillation frequency multiple I) are inputted to the oscillation frequency calculation unit 25 of the machining state calculation unit 12. This feature allows the operator to more easily perform the input operation while checking an oscillation frequency that is re-outputted in synchronization with the input value.

According to the present embodiment, the feed amount per relative rotation of the cutting tool T and the workpiece W (feed amount F) and the information regarding an oscillation amplitude with respect to the feed amount per relative rotation of the cutting tool T and the workpiece W (oscillation amplitude multiple K) are inputted to the oscillation amplitude calculation unit 26 of the machining state calculation unit 12. This feature allows the operator to more easily perform the input operation while checking an amplitude that is re-outputted in synchronization with the input value.

According to the present embodiment, the relative spindle speed of the cutting tool T and the workpiece W (spindle speed S), the feed amount per relative rotation of the cutting tool T and the workpiece W (feed amount F), the information regarding the number of oscillations per relative rotation of the cutting tool T and the workpiece W (oscillation frequency multiple I), and the information regarding an oscillation amplitude with respect to the feed amount per relative rotation of the cutting tool T and the workpiece W (oscillation amplitude multiple K) are inputted to the maximum acceleration calculation unit 27 of the machining state calculation unit 12. This feature allows the operator to more easily perform the input operation while checking a maximum acceleration that is re-outputted in synchronization with the input value.

Next, embodiments different from the first embodiment will be described. In the following description, components in common with the above-described embodiment are denoted by the same reference signs, and detailed description thereof is omitted as appropriate.

### Second Embodiment

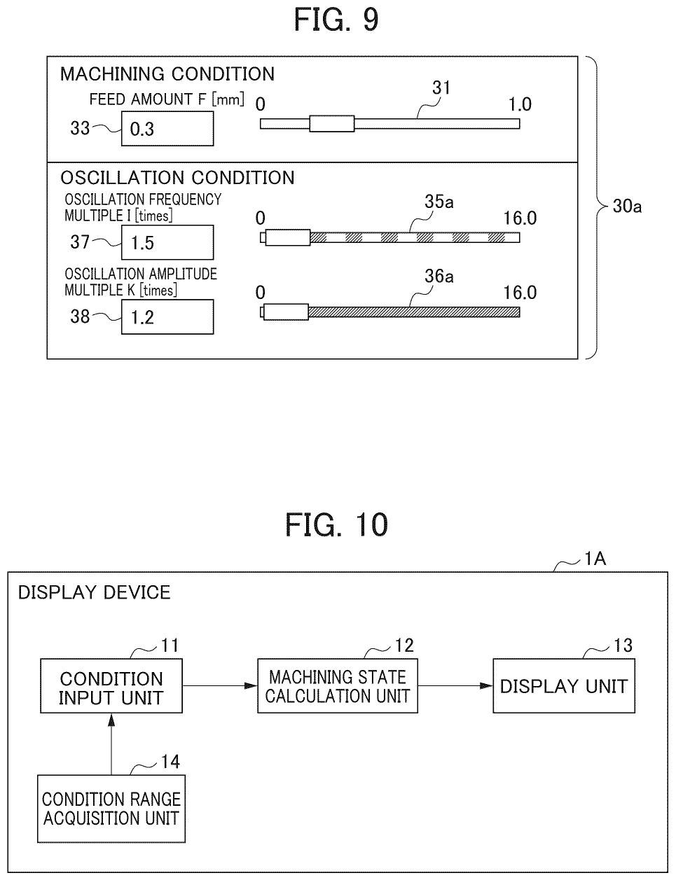

FIG. 9 is a diagram illustrating an example of an image of an input section 30a according to a second embodiment that clearly shows a range in which chip shredding is possible. In the example illustrated in FIG. 9, for the oscillation condition, a slider bar 35a via which the oscillation frequency multiple I [times] is inputted and a slider bar 36a via which the oscillation amplitude multiple K [times] of the oscillation condition is inputted each distinguishably show ranges in which chips shredding is possible and ranges in which chip shredding is impossible in different colors.

Whether chip shredding is possible or not in a range may be set in advance by an operator, or may be set by the chip shredding determination unit 22 based on a value inputted in advance.

In the slider bar 35a for the oscillation frequency multiple I [times], ranges in which chip shredding is possible and ranges in which chip shredding is impossible are alternately shown in different colors in the longitudinal direction of the slider bar 35a, so that the ranges in which chip shredding is possible are intermittently arranged. The slider bar 36a via which the oscillation amplitude multiple K [times] is imputed shows, by colors, that substantially the entire input region except for the left end portion indicates a range in which chip shredding is possible.

The condition input unit 11 sets the input section 30a such that the user's operations on both the slider bar 35a and the slider bar 36a are accepted only in the ranges in which chip shredding is possible. Therefore, the operator cannot move the sliders of the slider bars 35a and 36a to the ranges in which chip shredding is impossible.

As described above, in the display device 1 for a machine cool according to the second embodiment, the condition input unit 11 clearly shows ranges in which chip shredding is possible, in the input section 30a (the slider bar 35a and the slider bar 36a). This feature allows the operator to smoothly perform the input operation on the input section 30a while easily grasping the ranges in which chip cutting is possible.

The condition input unit 11 of the second embodiment sets limits within which the input secion 30a is operable, based on the ranges in which chip shredding is possible. Due to this feature, only the values corresponding to the ranges in which chip shredding is possible can be set, thereby making it possible to reliably avoid a Situation in which chips are not appropriately shredded.

In the second embodiment, the ranges are displayed to be distinguishable by colors, but they may be displayed to be distinguishable by shapes or the like.

### Third Embodiment

FIG. 10 is a functional block diagram of a display device 1A for a machine tool according to a third embodiment. As illustrated in FIG. 10, the display device 1A for a machine tool according to the third embodiment is the same as the display device 1 for a machine tool according to the first embodiment except that the display device 1A includes a condition range acquisition unit 14.

In the third embodiment, a machining condition range and a oscillation condition range can be designated. The condition range acquisition unit 14 acquires the machining condition range and the oscillation condition range from an input unit such as a keyboard or a touch display or an input section (not shown) such as an external computer.

The machining condition range includes, for example, a range of the feed amount [mm] and a range of the cutting edge [mm]. The operator can designate the range of the feed amount [mm] to 0 to 1.0 or a range different therefrom, and designate the range of the cutting edge [mm] to 0 to 1.0 or a range different therefrom, via an input section (not shown).

The oscillation condition range includes, for example, a range of the oscillation frequency multiple I [times] and a range of the oscillation amplitude multiple K [times]. The operator can designate the range of the oscillation frequency multiple I [times] to 0 to 16.0 or a range different therefrom, and designate the range of the oscillation amplitude multiple K [times] to 0 to 16.0 or a range different therefrom, via the input section (not shown)

As described above, the display device 1a for a machine tool according to the third embodiment further includes the condition range acquisition unit 14 that acquires a machining condition range and an oscillation condition range that are allowed to be inputted, and the condition input unit. 11 receives an input of a machining condition and an oscillation condition based on the input ranges acquired by the condition range acquisition unit 14. Due to this feature, in which the input range is designated in advance, it possible to realize a situational interface that the operator can use more easily.

Moreover, the configuration of the machining state calculation unit 12 of the above-described embodiments can be appropriately changed according to the circumstances by, for example, omitting a part of the functions or adding another function. The configuration of the third embodiment may be combined with the configuration of the second embodiment. Furthermore, the display unit 13 may be configured to display items different from those described in the above embodiments.

It should be noted that the present disclosure is not limited to the above-described embodiments, and modifications and improvements within a range in which the object of the present disclosure can be achieved are encompassed in the present disclosure.

### EXPLANATION OF REFERENCE NUMERALS

1: Display device for a machine tool
11: Condition input unit
12: Machining state calculation unit
13: Display unit
21: Cutting path calculation unit
22: Chip shredding determination unit
23: Chip length calculation unit
24: Surface roughness calculation unit
25: Oscillation frequency calculation unit
26: Oscillation amplitude calculation unit
27: Maximum acceleration calculation unit

1. A display device for a machine tool that performs machining while relatively oscillating a cutting tool and a workpiece, the display device comprising:
a condition input unit configured to receive an input of at least one of a machining condition or an oscillation condition via an input section that allows an input value to be consecutively changed;
a machining state calculation unit configured to calculate a machining state in response to an input of the machining condition and the oscillation condition; and
a display unit configured to display the machining state calculated.

2. The display device for a machining tool according to claim 1, wherein
the condition input unit clearly shows, in the input section, a range in which chip shredding is possible.

3. The display device for a machining tool according to claim 1, wherein
the condition input unit sets limits within which the input section is operable, based on the range in which chip shredding is possible.

4. The display device for a machining tool according to claim 1, further comprising:
a condition range acquisition unit configured to acquire a designated input range of the machining condition and a designated input range the oscillation condition, wherein
the condition input unit receives an input of the machining condition and the oscillation condition based on the designated input ranges.

5. The display device for a machining tool according to claim 1, wherein
the machining state calculation unit comprises
a cutting path calculation unit configured to calculate a relative cutting path of the cutting tool and the workpiece,
a chip shredding determination unit configured to determine whether or not chip shredding is possible,
a chip length calculation unit configured to calculate a length of a chip of the workpiece,
a surface roughness calculation unit configured to calculate a surface roughness of the workpiece,
an oscillation frequency calculation unit configured to calculate an oscillation frequency of a relative oscillation of the cutting tool and the workpiece,
an oscillation amplitude calculation unit configured to calculate an oscillation amplitude of a relative oscillation of the cutting tool and the workpiece, and
a maximum acceleration calculation unit configured to calculate a maximum acceleration of a relative oscillation of the cutting tool and the workpiece.

6. The display device for a machining tool according to claim 5, wherein
a feed amount per relative rotation of the cutting tool and the workpiece,
information regarding a number of oscillations per relative rotation of the cutting tool and the workpiece, and
information regarding an oscillation amplitude with respect to the feed amount per relative rotation of the cutting tool and the workpiece
are inputted to the cutting path calculation unit of the machining state calculation unit.

7. The display device for a machining tool according to claim 5, wherein
information regarding a number of oscillations per relative rotation of the cutting tool and the workpiece, and
information regarding an oscillation amplitude with respect to a feed amount per relative rotation of the cutting tool and the workpiece
are inputted to the chip shredding determination unit of the machining state calculation unit.

8. The display device for a machining tool according to claim 5, wherein
information regarding a number of oscillations per relative rotation of the cutting tool and the workpiece, and
information including a distance from a center of the relative rotation of the cutting tool and the workpiece are inputted to the chip length calculation unit of the machining state calculation unit.

9. The display device for a machining tool according to claim 5, wherein
a feed amount per relative rotation of the cutting tool and the workpiece,
a cutting edge shape of the cutting tool,
information regarding a number of oscillations per relative rotation of the cutting tool and the workpiece, and
information regarding an oscillation amplitude with respect to the feed amount per relative rotation of the cutting tool and the workpiece
are inputted to the surface roughness calculation unit of the machining state calculation unit.

10. The display device for a machining tool according to claim 5, wherein
a relative spindle speed of the cutting tool and the workpiece, and
information regarding a number of oscillations per relative rotation of the cutting tool and the workpiece
are inputted to the oscillation frequency calculation unit of the machining state calculation unit.

11. The display device for a machining tool according to claim 5, wherein
a feed amount per relative rotation of the cutting tool and the workpiece, and
information regarding an oscillation amplitude with respect to the feed amount per relative rotation of the cutting tool and the workpiece
are inputted to the oscillation amplitude calculation unit of the machining state calculation unit.

12. The display device for a machining tool according to claim 5, wherein
a relative spindle speed of the cutting tool and the workpiece,
a feed amount per relative rotation of the cutting tool and the workpiece,
information regarding a number of oscillations per relative rotation of the cutting tool and the workpiece, and
information regarding an oscillation amplitude with respect to the feed amount per relative rotation of the cutting tool and the workpiece are inputted to the maximum acceleration calculation unit of the machining state calculation unit.
